(19) United States
(12) Patent Application Publication
(10) Pub. No.: US 2023/0402842 A1
(43) Pub. Date: Dec. 14, 2023

(54) LOAD CONTROL PRIORITY GROUPING SYSTEM AND METHODS OF USE

(71) Applicants: Johua MacFie, Lubbock, TX (US); Mark Harral, Ft Stockton, TX (US); Sanka Liyanage, Lubbock (LK)

(72) Inventors: Johua MacFie, Lubbock, TX (US); Mark Harral, Ft Stockton, TX (US); Sanka Liyanage, Lubbock (LK)

(21) Appl. No.: 17/835,039

(22) Filed: Jun. 8, 2022

(51) Int. Cl. H02J 3/00; H02J 13/00; H02J 3/14; G05B 15/02

(52) U.S. Cl. CPC H02J 3/003; H02J 13/00002; H02J 3/144; G05B 15/02; G06Q 50/06

(57) ABSTRACT

Disclosed herein is a system and method of use for managing loads. More specifically, the present invention generally relates to a system and method of use for managing loads, which utilizes groupings to determine what resources are turned off for a given load shed situation or what resources are turned on for a given load increase situation. In one embodiment the system is comprised of at least one digitally controlled switch being communicatively coupled with a user interface for controlling the digitally controlled switches. The digitally controlled switches are combined into priority dropout groups.

### STATEMENT REGARDING FEDERALLY SPONSORED RESEARCH OR DEVELOPMENT

This invention was made with government support under DE-AR0000704 awarded by the Department of Energy. The government has certain rights in the invention.

### CROSS-REFERENCE TO RELATED APPLICATIONS

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to a system and method of use for managing loads. More specifically, the present invention generally relates to a system and method of use for managing loads, which utilizes groupings to determine what resources are turned off for a given load shed situation or what resources are turned on for a given load increase situation.

### BACKGROUND OF THE INVENTION

Without limiting the scope of the disclosed system, the background is described in connection with a novel system and method of use for managing loads, which utilizes groupings to determine what resources are turned off for a given load shed situation or what resources are turned on for a given load increase situation.

The invention provides a system that, when used for load control, will bridge the gap between end users and utilities, and/or grid operators. The gap exists due to the end users need to have on demand power while the utility has limitations to its power availability. At the edge of this gap lies blackouts, rolling blackouts, and brownouts. Within this gap lies elevated prices due to high demand countered by low supply.

Currently, solutions like rolling blackouts are stark, unneeded, and are a dangerous answer to a demand/supply problem that exists due to a lack of agreement and communication.

While all of the aforementioned systems and methods may fulfill their unique purposes, none of them fulfill the need for a practical, effective, and efficient means for a load managing system. It is an object of the present invention to overcome these shortcomings in the prior art.

Therefore, the present invention proposes a novel system and method of use for managing loads, which utilizes groupings to determine what resources are turned off for a given load shed situation or what resources are turned on for a given load increase situation.

### BRIEF SUMMARY OF THE INVENTION

The present invention, therefore, provides for a device and method of use for managing loads. More specifically, the present invention generally relates to a system and method of use for managing loads, which utilizes groupings to determine what resources are turned off for a given load shed situation or what resources are turned on for a given load increase situation.

In one embodiment the system is comprised of at least one digitally controlled switch being communicatively coupled with a user interface for controlling the digitally controlled switches. The digitally controlled switches are combined into priority dropout groups.

The load control priority grouping system manages which device should be turned off next in a load shed situation and which device is considered the most vital to be turned back on when loading is needed or warranted. This allows an arrangement between the end user of a set of loads and a controlling entity, such as a utility or power management program, to be had. With this arrangement the end user can keep vital loads running by placing them deeper into the priority dropout grouping while allowing non-vital loads to be changed to control gains in overall efficiency and/or health of the grid.

The system allows the end user to choose a priority number for each of its assets which in turn groups their assets into that priority grouping. The grid operator or utility can then use that information to incrementally turn off assets one at a time to reduce demand and increase user supply, instead of current state of the art options, some of which have been previously mentioned. These assets will turn off based on the end user's choice usually starting with less important non-threatening or emergency loads.

In summary, the present invention discloses a novel system and method of use for managing loads. More specifically, the present invention generally relates to a system and method of use for managing loads, which utilizes groupings to determine what resources are turned off for a given load shed situation or what resources are turned on for a given load increase situation.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a front view of the digitally controlled switch of the load control priority grouping system in accordance with embodiments of the disclosure;

FIG. 2 is a back view of the digitally controlled switch of the load control priority grouping system in accordance with embodiments of the disclosure;

FIG. 3 is a schematic showing a digitally controlled switch naming convention of the load control priority grouping system in accordance with embodiments of the disclosure;

FIG. 4 is a flow chart of a software implementation of the load control priority grouping system in accordance with embodiments of the disclosure;

FIG. 5 is Cluster controller configuration of the priority grouping energy management system in accordance with embodiments of the disclosure;

FIG. 6 is the control hierarchy of the software deployment of the load control priority grouping system with embodiments in this disclosure;

FIG. 7 is a priority grouping diagram of the load control priority grouping system in accordance with embodiments of the disclosure;

FIG. 8 is a digitally controlled switch user interface of the load control priority grouping system in accordance with embodiments of the disclosure.

### DETAILED DESCRIPTION OF THE INVENTION

Disclosed herein is a system and method of use directed to a load managing system. The numerous innovative teachings of the present invention will be described with particular reference to several embodiments (by way of example, and not of limitation).

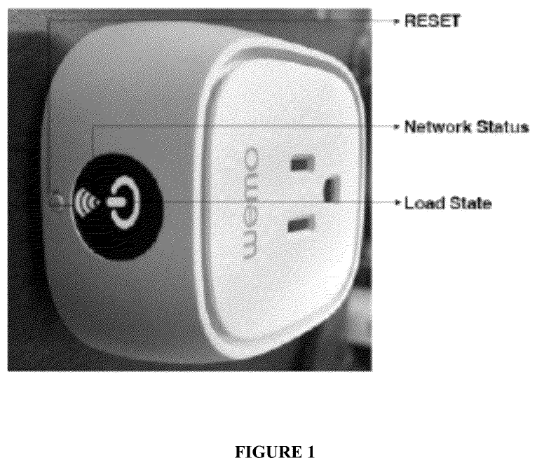

Reference is first made to FIG. 1, a front view of a digitally controlled switch used by the load control priority grouping system in accordance with embodiments of the disclosure. The objective of this system is to communicate with and allow control of multiple digitally controlled switches, via a single application program interface, API, located on the local network. This API allows a single binary or trinary signal to make energy increase/decrease changes. Ultimately this API feeds into a priority-based list that shuts down loads based on a user set priority number. This allows the highest priority items to be left on until demand warrants their eventual shut down. In this fashion, non-priority loads can be shed freely for small demand changes while allowing full load shed in emergency situations. In an embodiment the digitally controlled switches used to present this work are WeMo Insight switches, further denoted as Wemos.

The Wemo insight is a digitally controlled relay between a device and a wall outlet. The Wemo has the capability to transmit certain parameters, such as the current power consumption of the attached, wirelessly. The WeMo insight comes in a couple of different packages depending on the country of purchase. All variants have the same software protocols from country to country however the plug shape varies. In an embodiment, labeled specifications set input and output voltage to 120 V˜ at 60 Hz with a maximum current capability of 15 A.

The Wemo communicates using Universal Plug and Play, UPnP, via Hypertext Transfer Protocol for Secure communication, HTTPS, Simple Object Access Protocol, SOAP, and Extensible Markup Language, XML, over Internet Protocol, IP. The use of UPnP, which is baked into the WeMo firmware. In an embodiment, the system relies on the underlying network controls, HTTPS, SOAP, and XML rather than the overhead UPnP.

HTTPS is the backbone of how communication is handled between the WeMo and other devices. HTTP boiled down just means communication between a client and a server. In this instance devices trying to control the Wemo would be considered the client while the Wemo itself is the server. HTTP allows the clients to submit requests to the server. These requests are stateless meaning past events have no direct bearing on current requests, as a result states are achieved through other means. SOAP is a messaging protocol that uses XML for its data format and HTTP to communicate with devices.

In an embodiment, the XML markup isn't directly available to us and as such utilize an HTTP GET request to gather that data. This is done by sending a request through a web browser, formatted as [IP]:[PORT]/evenservice.xml, to a Wemo connected to the same local network. If this HTTP request is successful, then the web browser will display the current actions the WeMo device can perform written in XML. Using this method, the UPnP protocols can be bypassed saving the local network from a large amount of traffic.

The following section covers the hardware specifics, RF interference and network congestion encountered, and the approach to create router isolation. This section also covers the name scheme created to aggregate the desired characteristics of the load.

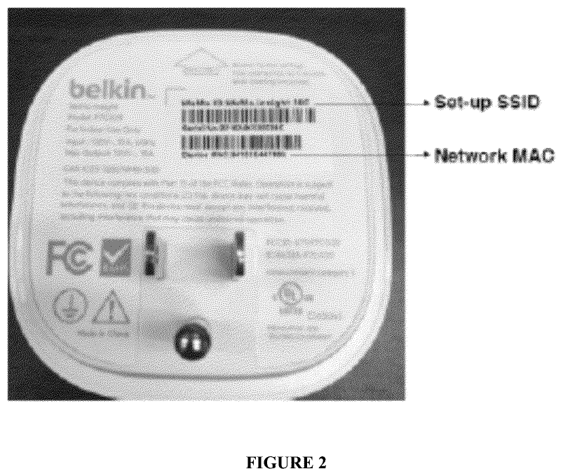

Reference is next made to FIG. 2, a back view of the digitally controlled switch of the load control priority grouping system in accordance with embodiments of the disclosure. Belkin's WeMo Insight is controlled natively through Belkin's WeMo application that is only available to android and iOS mobile devices. The WeMo sports a compact design and a simple set-up. FIG. 2 shows the physical features of the device and the printed identifiers.

Each WeMo has two network interfaces; each with their own MAC address. The first interface is for the set-up mode. When set-up mode is enabled, the WeMo will disable the network facing interface. The setup mode's MAC address is one hexadecimal decremented from the one provided on the device. The WeMos network status light flashes amber and it broadcasts its unique 2.4 GHz SSID. Once the initial set-up is completed, the WeMo disables the set-up mode, and enables the network facing interface.

The application interacts with the smart socket through the UPnP protocol that sends out a command to look up which WeMos are connected to the network. The protocol limits the amount of WeMos that can interact with the application at once. All the devices are active when the application is launched which gradually causes network congestion. Both WeMo connectivity modes work on 2.4 GHz band. When the limit of WeMos is reached, the set-up mode contributes to network congestion, and further limits the process of pairing multiple WeMos to the network.

The first approach was to create signal attenuation by increasing the distance of the WeMos in set-up mode from the network facing WeMo. This approach was taken further by implementing RF shielding around the access points to attenuate the signal emitted from a WeMo in set-up mode. The access points were relocated closer to the network facing WeMo. A galvanized steel sheet was placed behind the access points which were oriented at an angle facing the paired WeMos.

The shielding method proved successful in mitigating the signal of the WeMos in set-up mode. Our next task was to control the network traffic caused by the number of network-facing WeMos. The smart socket was not built with the ability to switch easily between access points with the same SSID. Herein disclosed is a WeMo cluster controller device to cope with the network traffic by network facing WeMos. Raspberry-Pi single board computer is used as the hardware platform for the cluster controller device, and it consists of two network interfaces, ethernet and wireless. The wireless interface is used to host wifi access point, which acts as the access point for the network facing WeMos. The ethernet interface is used to connect the cluster controller device to the main network. In this way, we can isolate groups of WeMo switches in to wifi networks with unique SSIDs. Furthermore, cluster controller devices can execute control commands at the local level. To enable the local control capabilities of the cluster controller, we have developed python-based software drivers for WeMo smart switches.

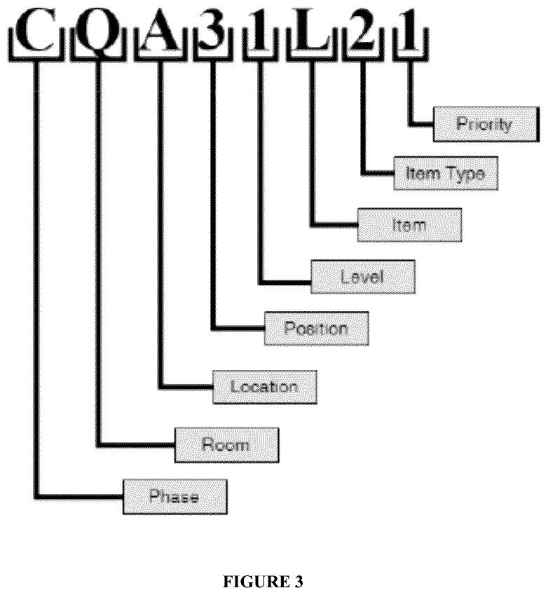

Reference is now made to FIG. 3, a schematic showing a digitally controlled switch naming convention of the load control priority grouping system in accordance with embodiments of the disclosure. FIG. 3 shows the configuration of the WeMO cluster controller device. WeMos are still prone to network congestion when updating firmware since the application calls for every WeMo on the network to be updated simultaneously. Once the update is complete, each device requires a reset or power cycle in order to regain stability. The workaround has been to decommission most of the devices and perform firmware updates in groups. The issue with this method is that there are gaps in our dataset during this period. Due to the large number of Wemos on the network, a new method of naming each Wemo has been created. An eight-character naming scheme was created that uses key characteristics of the load to allow further aggregation via software. FIG. 3 below shows the naming scheme with a named load.

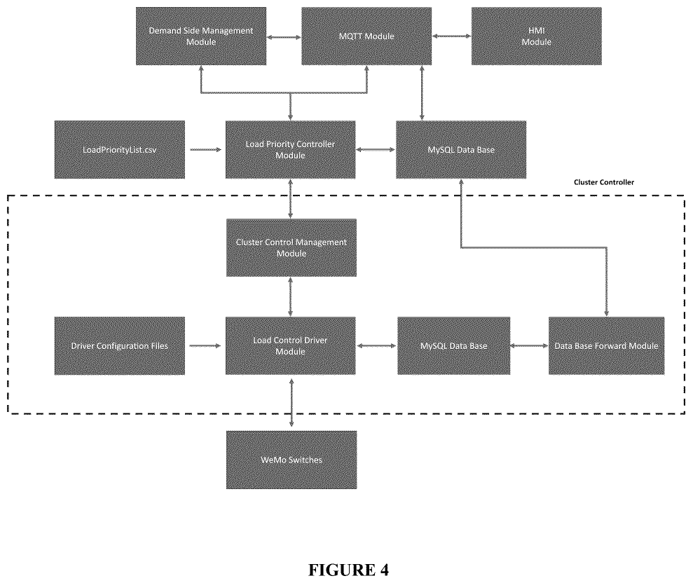

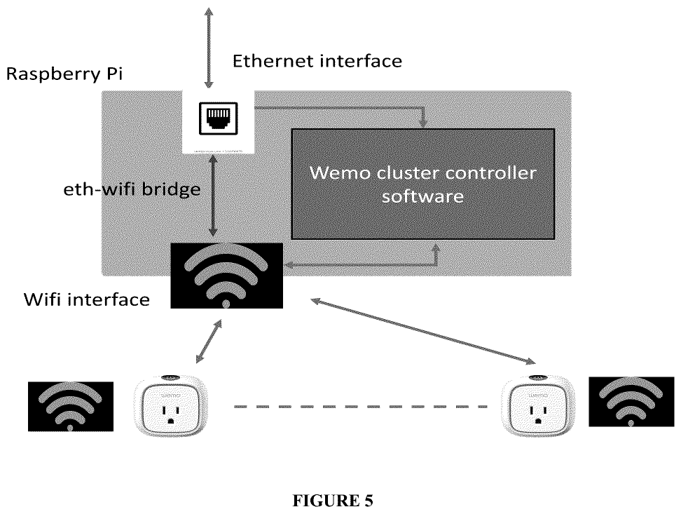

Reference is next made to FIG. 4, a flow chart of the software implementation of the load control priority grouping system and FIG. 5, the cluster controller configuration in accordance with embodiments of the disclosure. The implementation is designed in a modular fashion to enable the flexibility and the scalability of the system. FIG. 4 represents the interaction of different software modules in the system. All software modules except HMI are implemented in python and VOLTRRON API. The priority load controller module is the core of the load control priority grouping systems. It runs the load priority control algorithm discussed in this disclosure. Further the demand side management module operates as a supervisory controller to the priority load controller module. There are two modes of control, namely demand side management (DSM), manual control. During DSM operation, a power threshold is sent to the priority load controller module. During the manual operation the HMI sends the commands to the priority load controller module via a MQTT client. The priority load controller module decides which loads need to be on or off to maintain the given power threshold values based on the priority grouping provides by LoadPriorityList.csv file. Subsequently, the control signals for controlling WeMo switches are sent to the cluster controller units as seen in FIG. 5. Then according to FIG. 4, the cluster controller management module communicates with the priority load controller module and commands the load control driver module to set or read the operating states of network facing WeMos. Data logging is done in a redundant fashion by populating MYSQL databases in both cluster controller level and the load priority controller level.

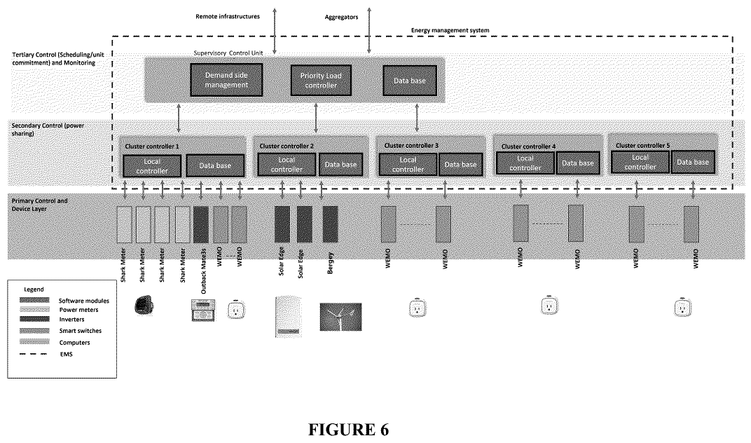

Reference is now made to FIG. 6, the control hierarchy of the software deployment of the load control priority grouping system that is described in FIGS. 4 and 5 in a real-world infrastructure in accordance with embodiments of the disclosure. The deployment is done in three control layers namely, tertiary control, secondary control, and primary control. Tertiary control layer consists of demand side management, load priority control, and HMI modules. Secondary level consists of cluster controller devises. Both primary and secondary level are equipped with MYSQL data bases for data collection. As it is shown in FIG. 6 cluster controllers are used to control and monitor WeMo switches, wind turbine, PV, battery, and smart meters. Primary level consists of filed devices. The connection to remote infrastructure represents the communication between remote facilities and the load control priority grouping system. Further the connection to the aggregator represents the communication between the utility and the load control priority grouping system. The system is coded primarily through a modular approach. This method hastens debugging while also allowing future proofing.

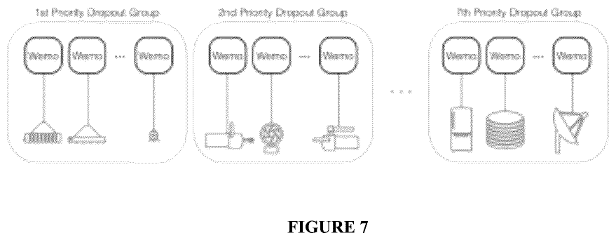

Reference is next made to FIG. 7, a priority grouping diagram of the load control priority grouping system in accordance with embodiments of the disclosure. The priority algorithm manages which device should be turned off next in a load shed situation and which device is considered the most vital to be turned back on when loading is needed or warranted. This allows an arrangement between the user of the Wemo and a controlling entity, such as a utility or a power management program, to be had. With this arrangement the user can keep vital loads running by placing them deeper into the priority dropout grouping while allowing non-vital loads to be changed to control gains in overall efficiency and/or health of the grid. As an example, FIG. 6 illustrates what priority grouping might look like. In this diagram the lights on the far left have been set to a higher priority dropout number because they are considered less essential than the pumps and fans in the 3rd priority dropout grouping. This grouping scheme is then paired with an algorithm to change overall load depending on the amount of change needed.

Another necessity that the priority algorithm takes care of is the issue of DER availability. Unfortunately, user level DER's cannot be considered systems that are on all the time, in other words, these systems are not dependable. These dependability issues arise from various factors ranging from small DER reliability to unforeseeable user actions. This algorithm negates these issues by rechecking a load that may not have been available and automatically changing priority level to accommodate a newly responsive DER.

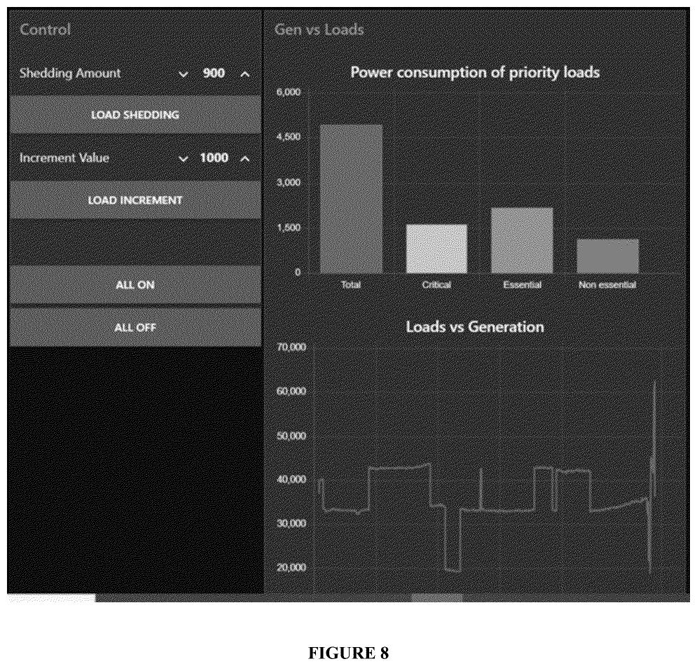

Reference is lastly made to FIG. 8, a user interface of the load control priority grouping system in accordance with embodiments of the disclosure. Wemo user interface shows a snapshot of the interface that is used to control and monitor plug loads attached to smart switches and electricity generators from the system.

In brief, the invention is directed to a load managing system.

The disclosed system and method of use is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the disclosed system or method of use, except as may be outlined in the claims.

Alternative applications for this invention include using this system or method of use in any application where managing devices based on groups is desired. Consequently, any embodiments comprising a one piece or multi piece system having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific system and method of use described herein. Such equivalents are considered to be within the scope of this invention and are covered by the claims.

All publications, references, patents, and patent applications mentioned in the specification are indicative of the level of those skilled in the art to which this invention pertains. All publications, references, patents, and patent application are herein incorporated by reference to the same extent as if each individual publication, reference, patent, or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The system and/or methods of use disclosed and claimed herein can be made and executed without undue experimentation in light of the present disclosure. While the system and methods of use of this invention have been described in terms of preferred embodiments, it will be apparent to those skilled in the art that variations may be applied to the system and/or methods of use and in the steps or in the sequence of steps of the method of use described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A load managing system as herein disclosed.

2. A method of use for a load managing system as herein disclosed.
